(19) United States
(12) Patent Application Publication
(10) Pub. No.: US 2016/0262380 A1
(43) Pub. Date: Sep. 15, 2016

(54) BIOCIDAL ARTICLE WITH PATTERNED ADHESIVE LAYER

(71) Applicant: Eastman Kodak Company, Rochester, NY (US)

(72) Inventor: Ronald Steven Cok, Rochester, NY (US)

(21) Appl. No.: 14/645,762

(22) Filed: Mar. 12, 2015

(51) Int. Cl. A01N 25/24; A01N 59/16; A01N 25/34

(52) U.S. Cl. CPC A01N 25/24; A01N 25/34; A01N 59/16

(57) ABSTRACT

A biocidal article includes a biocidal material layer having edges, an exposed side, and an adhesive side opposing the exposed side. A patterned adhesive layer is located in contact with the adhesive side and extends to the edges of the biocidal material layer. The patterned adhesive layer includes a non-biocidal portion and a biocidal portion. The biocidal portion includes biocidal materials and extends to at least one edge.

### CROSS REFERENCE TO RELATED APPLICATIONS

Reference is made to commonly-assigned co-pending U.S. patent application Ser. No. ______ (Attorney Docket No. K001962) filed concurrently herewith, entitled Biocidal Device with Patterned Adhesive Layer, by Cok et al, U.S. patent application Ser. No. 13/357,082, filed Jan. 24, 2012, entitled Ink Having Antibacterial and Antifungal Protection, by Blanton et al, to commonly-assigned co-pending U.S. patent application Ser. No. 14/519,425 filed Oct. 21, 2014, entitled Colored Biocidal Multi-Layer Structure, by Scheible et al, and U.S. patent application Ser. No. 14/526,595 filed Oct. 29, 2014, entitled Imprinted Multi-Layer Structure, by Cok et al, the disclosures of which are incorporated herein.

### FIELD OF THE INVENTION

The present invention relates to biocidal layers and devices having antimicrobial efficacy on a support.

### BACKGROUND OF THE INVENTION

Widespread attention has been focused in recent years on the consequences of bacterial and fungal contamination contracted by contact with common surfaces and objects. Some noteworthy examples include the sometimes fatal outcome from food poisoning due to the presence of particular strains of Escherichia coli in undercooked beef; Salmonella contamination in undercooked and unwashed poultry food products; as well as illnesses and skin irritations due to Staphylococcus aureus and other micro-organisms. Anthrax is an acute infectious disease caused by the spore-forming bacterium bacillus anthracis. Allergic reactions to molds and yeasts are a major concern to many consumers and insurance companies alike. In addition, significant fear has arisen in regard to the development of antibiotic-resistant strains of bacteria, such as methicillin-resistant Staphylococcus aureus (MRSA) and vancomycin-resistant Enterococcus (VRE). The U.S. Centers for Disease Control and Prevention estimates that 10% of patients contract additional diseases during their hospital stay and that the total deaths resulting from these nosocomially-contracted illnesses exceeds those suffered from vehicular traffic accidents and homicides. In response to these concerns, manufacturers have begun incorporating antimicrobial agents into materials used to produce objects for commercial, institutional, residential, and personal use.

Noble metal ions such as silver and gold ions are known for their antimicrobial properties and have been used in medical care for many years to prevent and treat infection. In recent years, this technology has been applied to consumer products to prevent the transmission of infectious disease and to kill harmful bacteria such as Staphylococcus aureus and Salmonella. In common practice, noble metals, metal ions, metal salts, or compounds containing metal ions having antimicrobial properties can be applied to surfaces to impart an antimicrobial property to the surface. If, or when, the surface is inoculated with harmful microbes, the antimicrobial metal ions or metal complexes, if present in effective concentrations, will slow or even prevent altogether the growth of those microbes. Recently, silver sulfate, Ag₂SO₄, described in U.S. Pat. No. 7,579,396, U.S. Patent Application Publication 2008/0242794, U.S. Patent Application Publication 2009/0291147, U.S. Patent Application Publication 2010/0093851, and U.S. Patent Application Publication 2010/0160486 has been shown to have efficacy in providing antimicrobial protection in polymer composites. The United States Environmental Protection Agency (EPA) evaluated silver sulfate as a biocide and registered its use as part of EPA Reg. No, 59441-8 EPA EST. NO. 59441-NY-001. In granting that registration, the EPA determined that silver sulfate was safe and effective in providing antibacterial and antifungal protection.

Antimicrobial activity is not limited to noble metals but is also observed in other metals such as copper and organic materials such as triclosan, and some polymeric materials.

It is important that the antimicrobial active element, molecule, or compound be present on the surface of the article at a concentration sufficient to inhibit microbial growth. This concentration, for a particular antimicrobial agent and bacterium, is often referred to as the minimum inhibitory concentration (MIC). It is also important that the antimicrobial agent be present on the surface of the article at a concentration significantly below that which can be harmful to the user of the article. This prevents harmful side effects of the article and decreases the risk to the user, while providing the benefit of reducing microbial contamination. There is a problem in that the rate of release of antimicrobial ions from antimicrobial films can be too facile, such that the antimicrobial article can quickly be depleted of antimicrobial active materials and become inert or non-functional. Depletion results from rapid diffusion of the active materials into the biological environment with which they are in contact, for example, water soluble biocides exposed to aqueous or humid environments. It is desirable that the rate of release of the antimicrobial ions or molecules be controlled such that the concentration of antimicrobials remains above the MIC. The concentration should remain there over the duration of use of the antimicrobial article. The desired rate of exchange of the antimicrobial can depend upon a number of factors including the identity of the antimicrobial metal ion, the specific microbe to be targeted, and the intended use and duration of use of the antimicrobial article.

Antimicrobial coatings are known in the prior art, for example as described in U.S. Patent Application Publication No. 2010/0034900. This disclosure teaches a method of coating a substrate with biocidal particles dispersed into a coating so that the particles are in contact with the environment. Non-planar coatings are also known to provide surface topographies for non-toxic bio-adhesion control, for example as disclosed in U.S. Pat. No. 7,143,709.

Fabrics or materials incorporating biocidal elements are known in the art and commercially available. U.S. Pat. No. 5,662,991 describes a biocidal fabric with a pattern of biocidal beads. U.S. Pat. No. 5,980,620 discloses a means of inhibiting bacterial growth on a coated substrate comprising a substantially dry powder coating containing a biocide. U.S. Pat. No. 6,437,021 teaches a water-insoluble polymeric support containing a biocide. Methods for depositing thin silver-comprising films on non-conducting substrates are taught in U.S. Patent Application Publication No. 2014/0170298.

However, as noted above, the antimicrobial coatings and materials lose their efficacy over time. Furthermore, there is a wide variety of different surfaces and structures for which anti-microbial efficacy is desirable.

### SUMMARY OF THE INVENTION

There is a need, therefore, for an anti-microbial article, device, and method that is readily replaced or refreshed and provides anti-microbial efficacy to a wide variety of different surfaces or structures.

In accordance with the present invention, a biocidal article comprises:

a biocidal material layer having edges, an exposed side, and an adhesive side opposing the exposed side; and

a patterned adhesive layer located in contact with the adhesive side and extending to the edges of the biocidal material layer wherein the patterned adhesive layer includes a non-biocidal portion and a biocidal portion, the biocidal portion including biocidal materials and extending to at least one edge.

The present invention provides an anti-microbial article, device, and method that is readily replaced or refreshed and provides anti-microbial efficacy to a wide variety of different surfaces or structures.

### BRIEF DESCRIPTION OF THE DRAWINGS

The above and other features and advantages of the present invention will become more apparent when taken in conjunction with the following description and drawings wherein identical reference numerals have been used to designate identical features that are common to the figures, and wherein:

FIG. 1 is a cross section illustrating an embodiment of the present invention;

FIG. 2 is a perspective of the embodiment of FIG. 1;

FIGS. 3-5 are perspectives of alternative embodiments of the present invention;

FIG. 6 is a cross section of an embodiment of the present invention formed into a roll;

FIG. 7 is a perspective of an embodiment of the present invention formed into a roll;

FIG. 8 is a cross section illustrating an embodiment of the present invention having biocidal particles;

FIGS. 9-12 are cross sections illustrating embodiments of the present invention;

FIG. 13 is a perspective illustrating an embodiment of the present invention with a cross section enlargement;

FIGS. 14 and 15 are cross sections illustrating other embodiments of the present invention;

FIGS. 16-17 are perspectives of embodiments of the present invention; and

FIGS. 18-26 are flow diagrams illustrating methods of the present invention.

The Figures are not drawn to scale since the variation in size of various elements in the Figures is too great to permit depiction to scale.

### DETAILED DESCRIPTION OF THE INVENTION

The present invention provides a biocidal article having a biocidal layer and an adhesive layer having a pattern of biocidal portions. By providing a patterned adhesive layer in which only some portions include biocidal materials, costs are reduced since biocidal materials are relatively expensive. The biocidal article is also an antimicrobial article and, in an embodiment, is a tape. In other embodiments of the present invention, the biocidal article is combined with a support to form a biocidal device, such as post, frame, or surface that is rendered biocidal by the biocidal article. Biocidal articles of the present invention are useful in combination with medical devices to form biocidal devices that are useful in medical facilities. As used herein, the term ‘biocide’ includes any material that renders biological organisms less potent, reduces their rate of reproduction, or kills them. Biocidal materials include antimicrobial materials.

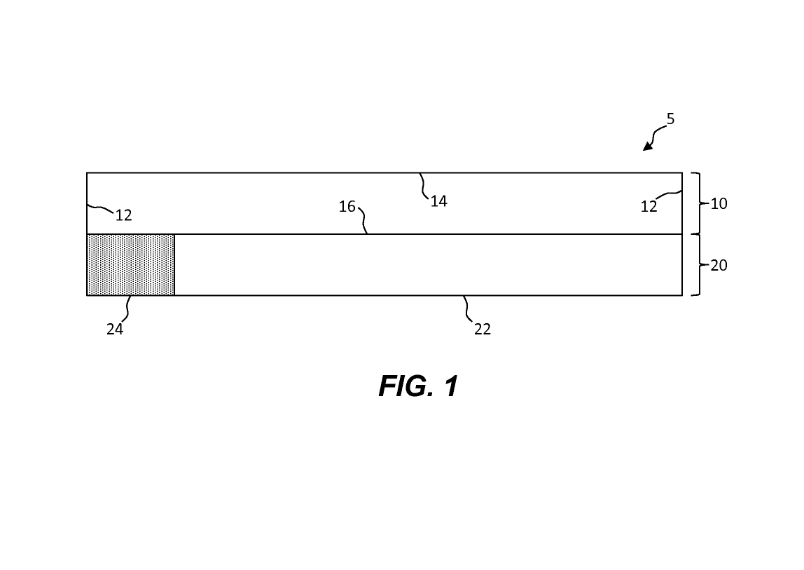

Referring to FIG. 1 in an embodiment of the present invention, a biocidal article 5 having a biocidal material layer 10 has edges 12, an exposed side 14, and an adhesive side 16 opposing the exposed side 14. A patterned adhesive layer 20 is located in contact with the adhesive side 16 and extends to the edges 12 of the biocidal material layer 10. Thus, the edges 12 are edges of the biocidal material layer 10 and also edges of the adhesive layer 20. The patterned adhesive layer 20 includes a non-biocidal and a biocidal portion 24. The biocidal portion 24 includes biocidal materials and extends to at least one edge 12.

The biocidal material layer 10 can be a single self-supporting layer that is infused or coated with biocidal material or it can include multiple layers, for example including a substrate coated with biocidal material. In various embodiments, such a substrate can also include biocidal material or not. If the substrate also includes biocidal material, the biocidal material can be the same, or different from that of the biocidal material coating on the substrate, in greater or lesser quantities or concentrations.

The biocidal material layer 10 or biocidal portion 24 of the patterned adhesive layer 20 is any layer or portion of a layer that resists the growth of undesirable biological organisms, including microbes, bacteria, or fungi or more generally, eukaryotes, prokaryotes, or viruses. In particular, the biocidal material layer 10 resists the growth, reproduction, or life of infectious micro-organisms or bacteria that cause illness or death in humans and especially antibiotic-resistant strains of bacteria.

The patterned adhesive layer 20 adheres to the adhesive side 16 of the biocidal material layer 10 and to other desired surfaces or supports as discussed further below. Both the non-biocidal portion 22 and the biocidal portion 24 of the patterned adhesive layer 20 are adhesive. According to embodiments of the present invention, the biocidal portion 24 is relatively more biocidal than the non-biocidal portion 22. In an embodiment, the non-biocidal portion 22 can have some biocidal effect, but does not include at least some biocidal materials that are included in the biocidal portion 24. In another embodiment, some or all of the biocidal materials included in the biocidal material layer 10 are included in the biocidal portion 24. Alternatively, the biocidal material layer 10 includes biocidal materials not found in the biocidal portion 24 or the biocidal portion 24 includes biocidal materials not found in the biocidal material layer 10. Similarly, in different embodiments, the adhesive used in the biocidal portion 24 is the same, or different, than the adhesive used in the non-biocidal portion 22 of the patterned adhesive layer 20. In an embodiment, the biocidal material layer 10 is curable, for example with heat or radiation. A variety of adhesives are useful for the patterned adhesive layer 20, both curable and incurable. For example, adhesives can include epoxies and resins, and can include cross linking materials responsive to heat or radiation. In an embodiment, curing the patterned adhesive layer 20 also at least partially cures the biocidal material layer 10. In an embodiment, the patterned adhesive layer 20 is at least partially cross linked to the biocidal material layer 10.

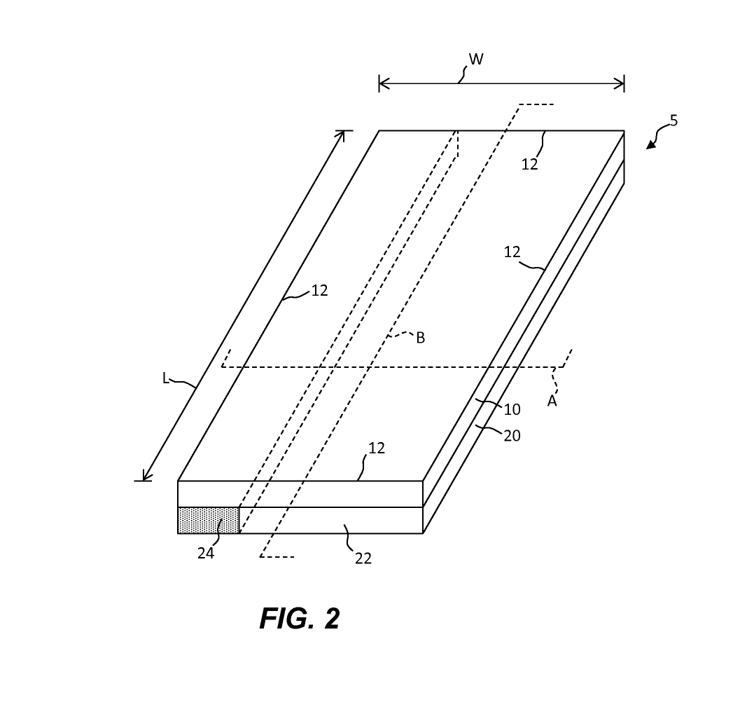

In various embodiments of the present invention, the biocidal material layer 10 and the patterned adhesive layer 20 form a sheet or the biocidal material layer 10 has four edges 12 and forms a rectangular layer. Referring to FIG. 2, the biocidal material layer 10 of the biocidal article 5 has a length L and a width W along edges 12 extending in different directions, for example orthogonal directions, as does the patterned adhesive layer 20. The biocidal portion 24 extends along the edge 12 of the length L of the biocidal article 5 and the non-biocidal portion 22 is adjacent to the biocidal portion 24 of the patterned adhesive layer 20. FIG. 1 is a cross section taken along the cross section line A of FIG. 2.

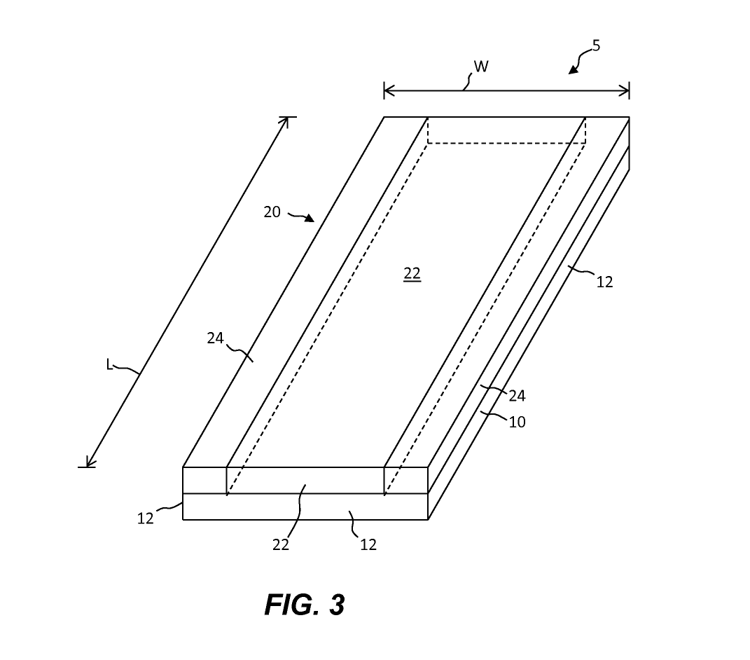

Referring generally to FIGS. 2-5, in various embodiments of the present invention, the biocidal portion 24 extends along different edges 12 of the biocidal article 5. As shown in FIGS. 1 and 2, the biocidal portion 24 extends along only one edge 12. Referring to FIG. 3, the biocidal portion 24 extends along two edges 12 so that the biocidal portion 24 of the patterned adhesive layer 20 forms strips adjacent to the edges 12 along the length L of the biocidal article 5 and the non-biocidal portion 22 forms a strip between the biocidal portions 24 along the length L. By adjacent to the edge 12 is meant that no non-biocidal portion 22 is between the biocidal portion 24 and the edge 12. Note that the FIG. 3 illustration is inverted from that of FIGS. 1 and 2, so that the biocidal material layer 10 is beneath the patterned adhesive layer 20. As will be readily appreciated by those knowledgeable in the art, the relative arrangement of the biocidal material layer 10 with respect to the patterned adhesive layer 20 is arbitrary as either layer is above or below the other depending on the orientation of the biocidal article 5 with respect to a viewer or user.

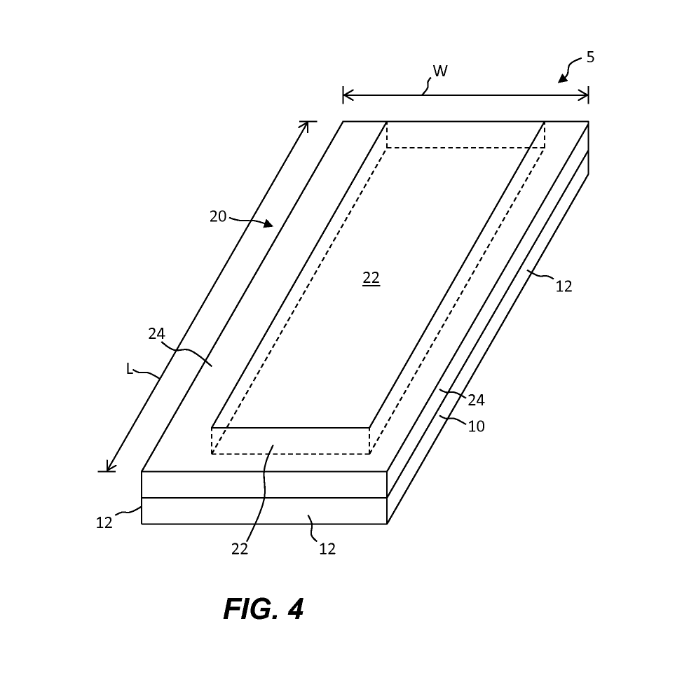

Referring to the embodiment of FIG. 4, the biocidal portion 24 extends along three edges 12, along both length L edges 12 and one width W edge 12. The central portion of the patterned adhesive layer 20 forms the non-biocidal portion 22, coated on the biocidal material layer 10. In FIGS. 1-4, the patterned adhesive layer 20 covers the biocidal material layer 10.

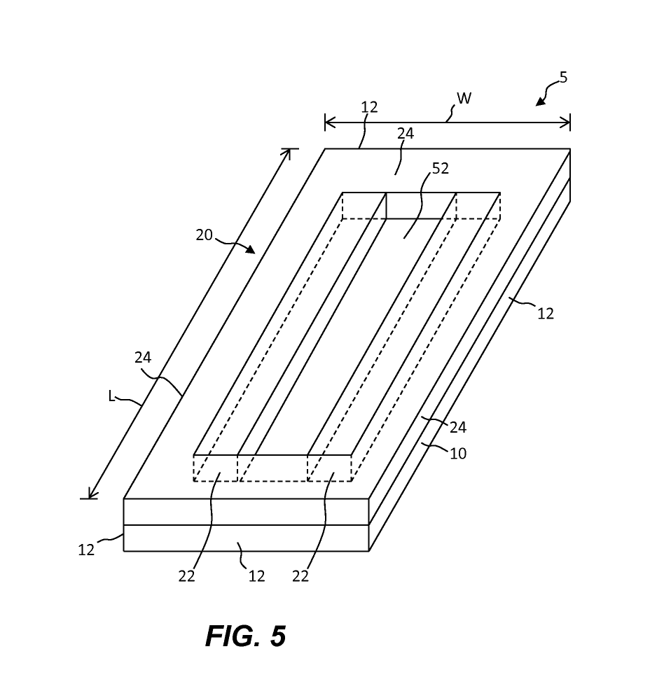

Referring to the embodiment of FIG. 5, the biocidal portion 24 extends along four edges 12, along both length L edges 12 and both width W edges 12. The central portion of the patterned adhesive layer 20 forms the non-biocidal portion 22, coated on the biocidal material layer 10. In the example of FIG. 5, a space 52 with no adhesive material is located in the center of the patterned adhesive layer 20. This demonstrates that although at least one biocidal portion 24 is adjacent to an edge 12, it is not necessary that the entire extent of the biocidal material layer 10 is coated with adhesive so that the patterned adhesive layer 20 is not necessarily continuous over the extent of the biocidal material layer 10 and the patterned adhesive layer 20 covers only a portion of the adhesive side 16 of the biocidal material layer 10. In various embodiments, the space 52 is located with the non-biocidal portion 22 or not, for example the space 52 is adjacent to the biocidal portion 24 or to an edge 12 or to any or all of these structures. In other embodiments, more than one space 52 is formed in the patterned adhesive layer 20; the spaces 52 are contiguous in one embodiment and are not contiguous in another embodiment.

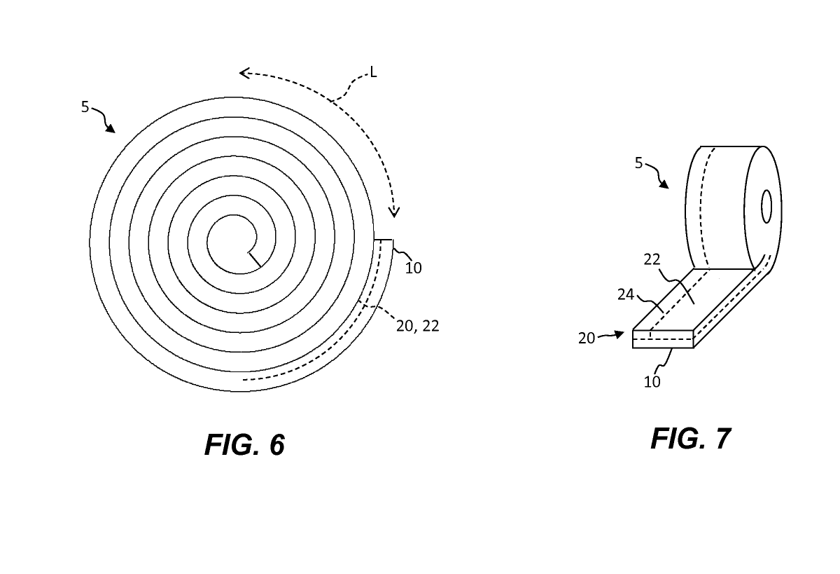

In a further embodiment, and as illustrated in FIGS. 2-5, the biocidal material layer 10 has length L greater than width W. Thus, the biocidal material layer 10 and the patterned adhesive layer 20 of the biocidal article 5 form a tape. As shown in FIG. 6, the length L of the tape is rolled into a spiral for convenience in storage and to protect both the biocidal material layer 10 and the patterned adhesive layer 20. The cross section of FIG. 6 is taken along the cross section line B of FIG. 2, except that the biocidal article 5 is wound in a spiral configuration rather than laid out flat. For clarity in illustration, the biocidal material layer 10 is distinguished from the patterned adhesive layer 20 and non-biocidal portion 22 by a dashed line along only a portion of the length L of the biocidal article 5. Although not shown, in an embodiment a protective release layer or liner is applied to the patterned adhesive layer 20 on a side of the patterned adhesive layer opposite the biocidal material layer 10. The protective release layer or lined can have an adhesive as well, for example on a side of the protective release layer or liner opposite the patterned adhesive layer 20.

FIG. 7 is a perspective of the spiral-wound structure of FIG. 6 with a portion of the biocidal article 5 extending in a line segment from the spiral structure, for example as usefully arranged in a tape dispenser. FIG. 7 shows an extended portion of the non-biocidal portion 22 and the biocidal portion 24 of the patterned adhesive layer 20 and the biocidal material layer 10 of the biocidal article 5. By grasping the extended portion of the biocidal article 5, the biocidal article 5 can be removed (peeled) from the spiral structure and the patterned adhesive 20 of the biocidal article 5 is applied to a surface or support to form a biocidal device as discussed further below. In a subsequent step, the biocidal article 5 is removed from the support or substrate, for example in a replacement step. Thus, in an embodiment the adhesive of the patterned adhesive layer 20 is a removable adhesive. In an alternative embodiment, the patterned adhesive layer 20 is initially a removable adhesive, the biocidal article 5 is applied to a support, and then the adhesive of the patterned adhesive layer 20 is cured to form a permanent bond and the biocidal article 5 is not removed from the support.

In order to enable rolls of the biocidal article 5, in some embodiments, the biocidal material layer 10 and the patterned adhesive layer 20 are elastic or flexible. In an embodiment, the biocidal material layer 10 is woven, is or includes a textile, cloth, or fabric and is, for example at least partly made from yarns having biocidal properties. Materials useful for such yarns are known in the art and commercially available. In another embodiment, biocidal material layer 10 is or includes plastic.

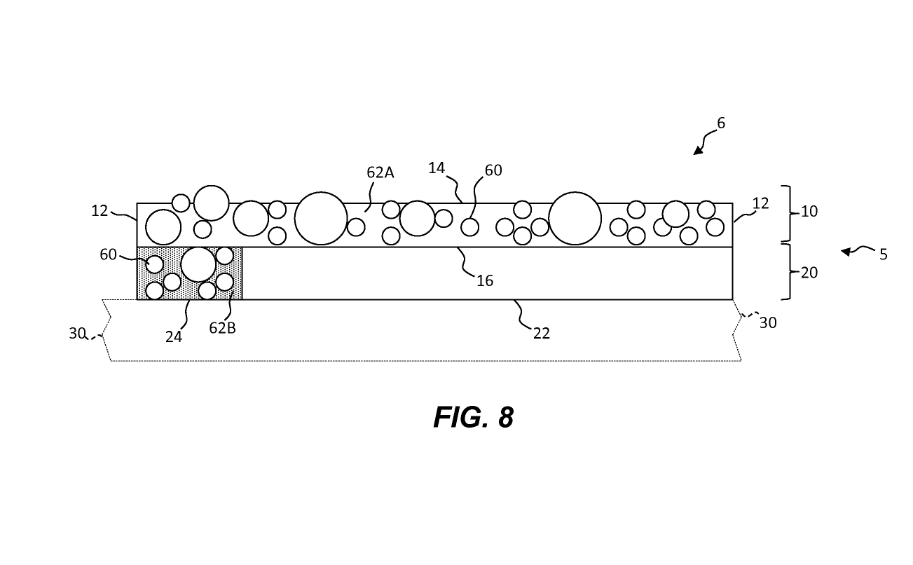

Turning to FIG. 8, in an embodiment of the present invention the biocidal article 5 includes biocidal material in the biocidal material layer 10. In one embodiment, the biocidal material is drugs; in another embodiment the biocidal material includes biocidal particles 60, for example particles including metal, ionic metal, metal salts, silver, silver salt, copper, copper salt, silver sulfate, silver components, copper components, or silver chloride. The biocidal particles 60 can have a variety of sizes, for example a diameter between 0.5 and 25 microns. As noted above, in an embodiment the same biocidal particles 60 are in the biocidal portion 24 adjacent to the edge 12 of the patterned adhesive layer 20 and not in the non-biocidal portion 22. In further embodiments, the biocidal particles 60 in the biocidal material layer 10 are located within a binder 62A and the biocidal particles 60 in the biocidal portion 24 are located within an adhesive binder 62B that is more adhesive than the binder 62A of the biocidal material layer 10. Thus, the patterned adhesive layer 20 of the biocidal article 5 preferentially adheres to a support 30, as shown, to form a biocidal device 6. In an embodiment, some or all of the biocidal particles 60 extend from the exposed side 14 of the biocidal material layer 10 and are exposed to the environment. Alternatively, the biocidal particles 60 do not extend from the exposed side 14 of the biocidal material layer 10 and are coated with the binder 62A or by another layer located over the biocidal material layer 10 (not shown). These coatings or layers can control the exposure of the biocidal particles 60 to the environment.

In one embodiment of the present invention, the biocidal material layer 10 has a structured surface, for example is not planar. Such structures, if properly chosen, can inhibit the reproduction of biological organisms and are made, for example, by imprinting or patternwise etching the exposed surface 14 of the biocidal material layer 10. In an additional embodiment, the biocidal material layer 10 is hydrophobic or oleophobic for the same reason.

In further embodiments of the present invention, the biocidal material layer 10 has a material layer color and the patterned adhesive layer 20 has an adhesive layer color different from the material layer color. In useful embodiments, the material layer color is blue or green or white or the adhesive layer color is red or orange. Such differences in color are useful in detecting by observation any imperfection in the layers, for example due to mechanical abrasion or environmental damage. Furthermore, the choice of colors is usefully chosen to represent that all is well or that danger is present. Alternatively, the biocidal material layer 10 or the patterned adhesive layer 20 is transparent.

In other embodiments, the biocidal portion 24 has an edge color and the non-biocidal portion 22 has a color that is different from the edge color. In a useful arrangement, the biocidal material layer 10 has a material layer color and the edge color is the same as the material layer color, usefully indicating biocidal portions of the biocidal article 5. In other embodiments, the colors are different.

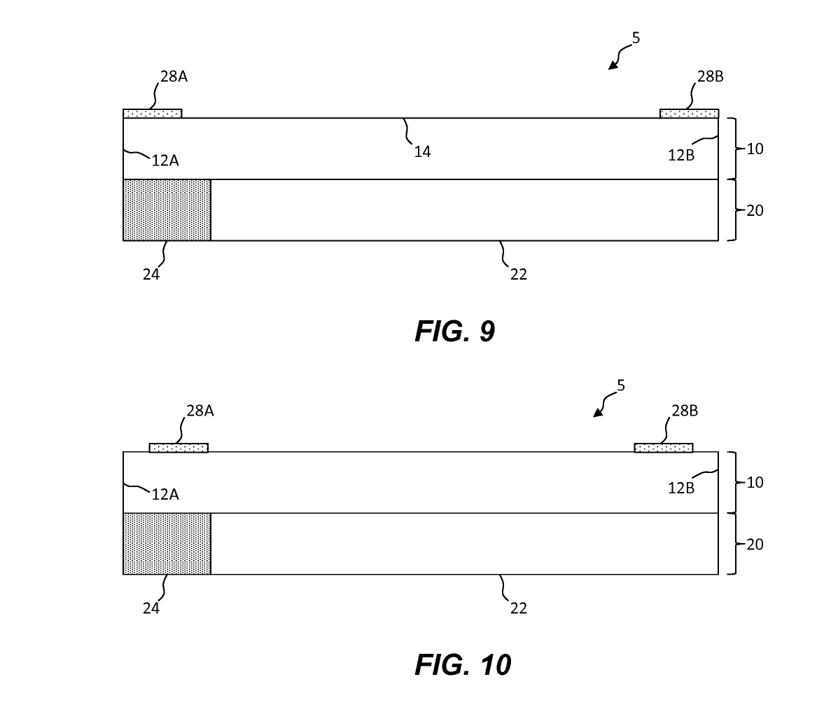

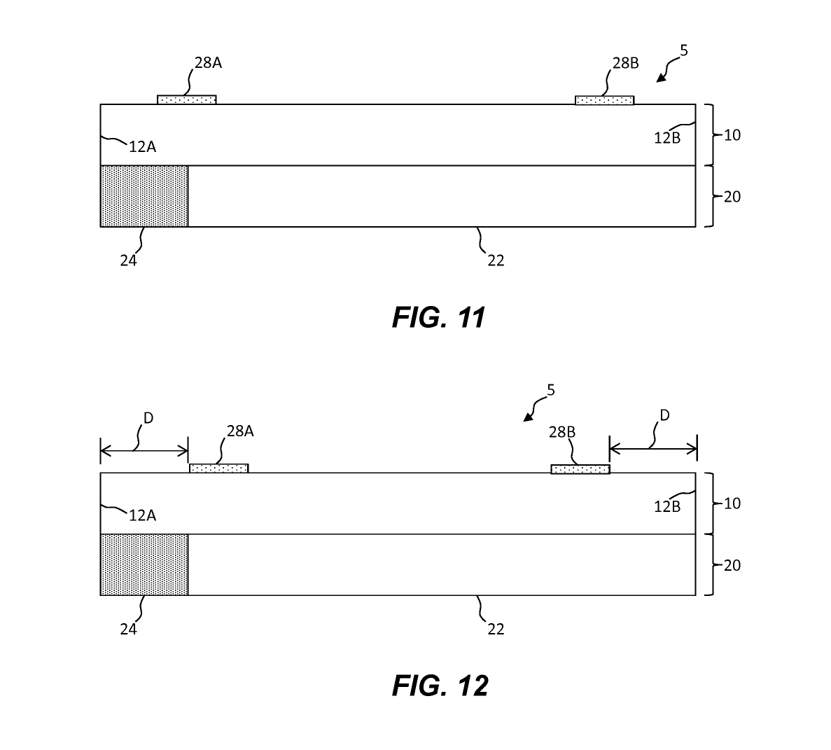

Referring to FIGS. 9-12, in different embodiments of the biocidal article 5 of the present invention, visible marks 28A and 28B are located on the exposed side 14 of the biocidal material layer 10 opposite the patterned adhesive layer 20. In FIG. 9, visible marks 28A and 28B are located adjacent to first and second portion edges 12A and 12B. Visible mark 28A indicates a first portion edge 12A adjacent to the biocidal portion 24. Visible mark 28B indicates a second portion edge 12B adjacent to the non-biocidal portion 22 of the patterned adhesive layer 20. Referring to FIG. 10, visible marks 28A and 28B are also located adjacent to first and second portion edges 12A and 12B. Visible mark 28A indicates a first portion edge 12A adjacent to the biocidal portion 24 and aligned on one side with the boundary between the biocidal portion 24 and the non-biocidal portion 22, thereby indicating the extent of the biocidal portion 24 on the biocidal material layer 10 adhesive side 16. Visible mark 28B indicates a second portion edge 12B adjacent to the non-biocidal portion 22 of the patterned adhesive layer 20 a similar distance from the second portion edge 12B. Referring to FIG. 11, visible marks 28A and 28B are located adjacent to first and second portion edges 12A and 12B. Visible mark 28A indicates a first portion edge 12A adjacent to the biocidal portion 24 and overlapping the boundary between the biocidal portion 24 and the non-biocidal portion 22. Visible mark 28B indicates a second portion edge 12B adjacent to the non-biocidal portion 22 of the patterned adhesive layer 20 a similar distance from the second portion edge 12B. Referring to FIG. 12, visible marks 28A and 28B are also located adjacent to first and second portion edges 12A and 12B. Visible mark 28A indicates a first portion edge 12A adjacent to the biocidal portion 24 and aligned on a side opposite the side of FIG. 10 with the boundary between the biocidal portion 24 and the non-biocidal portion 22 a distance D from the first portion edge 12A. Visible mark 28B indicates a second portion edge 12B adjacent to the non-biocidal portion 22 of the patterned adhesive layer 20 a similar distance D from the second portion edge 12B. The distance D from the visible mark 28A to the first portion edge 12A is not necessarily the same distance D as from the visible mark 28B to the second portion edge 12B. Such visible indications are useful when applying the patterned adhesive layer to the support 30, for example for aligning the biocidal article 5 with itself or other structural elements of the support 30.

The biocidal article 5 of the present invention can be constructed in a variety of ways. In a first way, a plastic substrate provides a surface, for example PET provided in a roll forming a web. A biocidal adhesive is prepared, for example by providing biocidal materials such as drugs or biocidal particles such as those listed above mixed into an adhesive. In a useful embodiment, a dispersion of biocidal particles 60 is formed in a carrier such as a liquid in and located on a layer, for example by coating, and then dried. The biocidal particles 60 can self-segregate in the liquid before the liquid is cured or dried. In an embodiment, the biocidal particles 60 self-segregate after the liquid is coated, for example over or on a layer, and before the liquid is cured or dried. In another embodiment, the self-segregating particles 60 aggregate at a layer surface. Making and coating liquids with dispersed biocidal particles 60 is known in the art. Alternatively, the biocidal particles 60 do not self-segregate.

The liquid is coated on a web, for example with hopper or curtain coating in two portions, the biocidal portion 24 along the edge of the web with the biocidal adhesive the non-biocidal portion 22 adjacent to the biocidal portion 24. Methods are known in the art for providing a patterned coating along a moving web. Optionally, the adhesive is partially cured or dried to provide a surface on which the biocidal material layer 10 is coated across the web. The biocidal material layer 10 is cured, for example by drying, heating, or exposing to radiation. The web is cut into desired lengths to provide the biocidal article of the present invention. In use, the support 30 is peeled from the patterned adhesive layer 20 and the patterned adhesive layer 20 of the biocidal article 5 is applied to the support 30.

In a second way, a substrate on which a surface on which a releasable adhesive is provided, the biocidal material layer 10 is applied over the adhesive, and the patterned adhesive layer 20 is formed on the biocidal material layer 10 forming the biocidal article 5 on the substrate. The biocidal article 5 is then removed from the substrate and applied to the support 30.

In a third way, the biocidal material layer 10 is a self-supporting structure, for example a polymer or resin cast on a surface and then removed from the surface or a textile or cloth having impregnated biocidal materials such as silver sulfate particles. The biocidal material layer 10 is then coated on the adhesive side with the patterned adhesive layer 20 forming the biocidal article 5. The biocidal article 5 is then applied to the support 30. In yet another alternative, one or more layers are formed on a substrate with a separating release layer, laminated, and the substrate removed using the release layer.

In any of these ways, after manufacturing and before application to a support 30, the biocidal article 5 is optionally stored in a configuration, for example in sheets, as a tape in a spiral (as shown in FIG. 6), a winding, or a Z-fold configuration. Optionally, the biocidal article 5 is provided in a dispenser. In embodiments, the biocidal article 5 is cured or processed in place on support 30, for example is a heat-shrink film or contains polyolefin, polyvinylchloride, polyethylene, or polypropylene.

In yet another aspect of the present invention, the patterned adhesive layer 20 is formed on the support 30 and the biocidal material layer 10 formed on the patterned adhesive layer 20. This method includes providing the support 30, forming the patterned adhesive layer 20 on the support 30, the patterned adhesive layer 20 having the non-biocidal portion 22 and the biocidal portion 24. The biocidal portion 24 includes biocidal materials and extends to at least one edge 12 of the patterned adhesive layer 20. A biocidal material layer 10 is formed with an adhesive side 16 in contact with the patterned adhesive layer 20 and an opposed exposed side 14, the biocidal material layer 10 extending to the at least one edge 12 of the patterned adhesive layer 20.

In an embodiment, the biocidal material layer 10 or patterned adhesive layer 20 is a polymer or contains polymers, for example polymers coated as a liquid or laminated and then cured with heat, drying, or radiation. The patterned adhesive layer 20 can be a pressure-sensitive adhesive or a curable adhesive. The support 30 can be rigid or flexible and for example is formed from metal, glass, or plastic. The support 30 can have any surface, planar or non-planar that is desired to resist the growth of biologically undesirable organisms, including microbes, bacteria, or fungi. For example, such non-planar layers are made in curable polymer layers with a stamp using imprinting methods known in the art to form indentations inhospitable to microbes. Alternatively, the biocidal material layer 10 is roughened by a treatment such as sandblasting or exposure to energetic gases or plasmas. In various applications, the support 30 is a surface of a structure, such as a wall, floor, table top, door, handle, cover, device surface, or any surface likely to come into contact with a human.

The biocidal article 5 is useful for reducing the quantity of bacteria on a surface and for preventing or mitigating the development of bio films of bacteria or other micro-organisms. The biocidal article 5 is applied and adhered to a support 30 which is desired to remain free from microbes. The biocide in the biocidal material layer 10 serves to kill or otherwise discommode bacteria, viruses, or other biological organisms that can impinge on the biocidal article 5 or the support 30. Since drugs and biocidal materials are relatively expensive, by patterning the adhesive costs are reduced. By properly applying the biocidal article 5 to a support 30 to form a biocidal device 6, efficacy of the biocidal article 5 is maintained.

Substrates, adhesives, patterned coating methods, and biocides are all known in the art, as are mechanisms for coating webs, cutting, stacking, and winding flexible substrates. Substrates are known to be flexible (e.g. plastic) or rigid (e.g. glass or metal), transparent or colored. In various embodiments, the biocidal material layer 10 and patterned adhesive layer 20 are 0.10 to 10 microns thick, or between 10 and 100 microns thick or between 100 microns and 1 mm thick. The biocidal material layer 10 and patterned adhesive layer 20 can have the same thickness, or the biocidal material layer 10 is thicker than the patterned adhesive layer 20, or the biocidal material layer 10 is thinner than the patterned adhesive layer 20. The layers are colored or transparent.

According to a further embodiment of the present invention and as illustrated in FIG. 8, the biocidal device 6 includes the biocidal material layer 10 having edges 12, the exposed side 14, and the adhesive side 16 opposing the exposed side 14. The patterned adhesive layer 20 is located in contact with the adhesive side and extends to the edges 12 of the biocidal material layer 10. The patterned adhesive layer 20 includes the non-biocidal portion 22 and the biocidal portion 24. The biocidal portion 24 includes biocidal materials and extends to at least one edge 12. The biocidal material layer 10 and the patterned adhesive layer 20 form the biocidal article 5. The biocidal device 6 also includes the support 30. The patterned adhesive layer 20 is adhered to at least a portion of the support 30 and at least a part of the biocidal portion 24 that extends along an edge 12 is exposed.

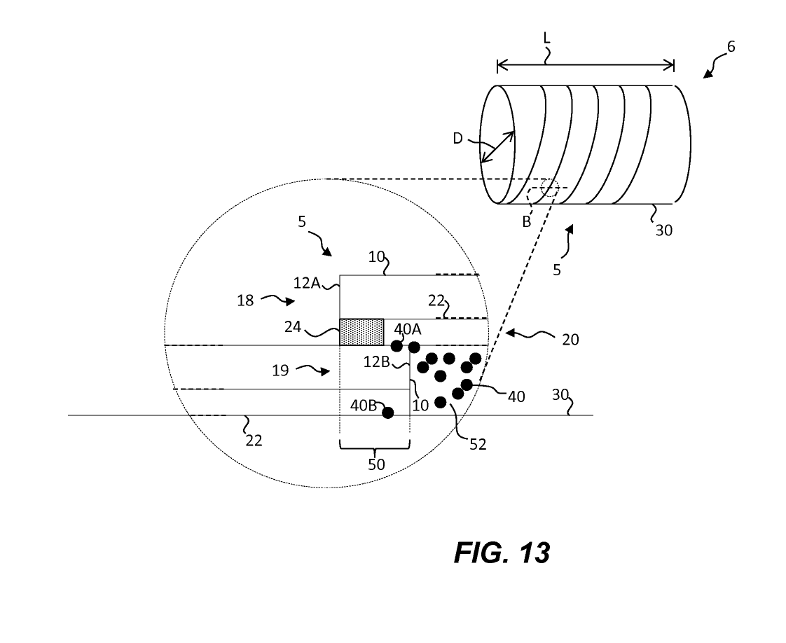

Referring to FIG. 13, the biocidal material layer 10 and the patterned adhesive layer 20 of the biocidal article 5 as shown in FIGS. 1 and 2 are wrapped helically or in a spiral around the support 30. In the example of FIG. 13, the support 30 is a cylinder with a diameter distance D and the biocidal article 5 is wrapped helically around the length L of the cylinder in such a way that the biocidal article overlaps itself to completely cover a portion of the support 30. As shown in the detailed enlargement portion of FIG. 13 in a cross section taken along cross section line B, a first portion 18 of the biocidal material layer 10 overlaps and is adhered to a second portion 19 of the biocidal material layer 10 different from the first portion 18 forming an overlap 50. The biocidal article 5 is wrapped so that the biocidal portion 24 of the patterned adhesive layer 20 is exposed to the environment at the edge 12A of the biocidal article 5. The non-biocidal portion 22 of the patterned adhesive layer 20 and the edge 12B are covered by subsequent helical wraps of the biocidal article 5 around the support 30.

As will be appreciated by those skilled in the mechanical arts, even if the biocidal article 5 is flexible, the space 52 will form adjacent to an overlap 50 between the first (top) portion 18 of the wrapped biocidal article 5 and the support 30. It is possible that this space 52 can support a reservoir of microbes 40, as shown. According to the present invention, if the microbes 40 attempt to migrate through the biocidal article 5, they will encounter the biocidal material layer 10. If the microbes 40A attempt to migrate through the first portion 18 of the patterned adhesive layer 20, they will encounter the biocidal portion 24. If the microbes 40B attempt to migrate through the second portion 19 of the patterned adhesive layer 20, they will also eventually encounter the biocidal portion 24. Thus, the present invention provides a barrier to the migration of any microbes 40 trapped between the biocidal article 5 and the support 30.

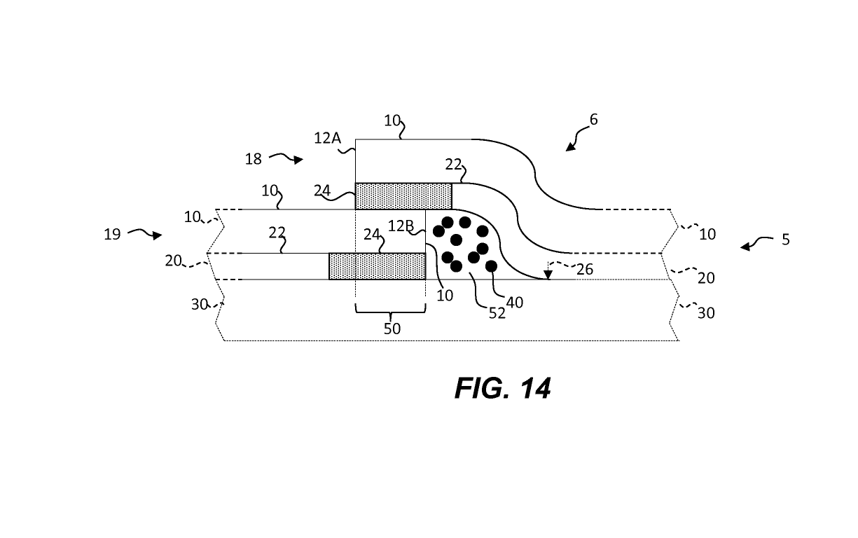

As illustrated in FIG. 13, the biocidal portion 24 does not extend beyond the overlap 50 so that no microbes 40 are directly exposed to biocidal material. Referring to the FIG. 14 embodiment of the biocidal device 6 having the patterned adhesive layer 20 on a biocidal material layer 10 of a biocidal article 5, the biocidal portion 24 of the first portion 18 extends past the overlap 50 between the first and second portions 18, 19 of the biocidal article 5. Thus, the microbes 40 in the space 52 are directly exposed to biocidal material in the biocidal portion 24. In a further embodiment, the second portion 19 is a biocidal portion 24 that includes biocidal material, for example corresponding to the biocidal article 5 structure shown in FIG. 3 with biocidal portions 24 on both edges 12A and 12B. In this further embodiment illustrated in FIG. 14, the microbes 40 are exposed to biocidal material in biocidal portions 24 in both the first and second portions 18, 19. The biocidal portion 24 of the second portion 19 can extend past the overlap 50, as shown, or, alternatively, the biocidal portion 24 of the second portion 19 does not extend past the overlap 50.

The patterned adhesive layer 20 of the first portion 18 extends past the space 52 to contact the support 30 at a contact point 26. In the embodiment illustrated in FIG. 14, the non-biocidal portion 22 of the first portion 18 contacts the support 30 at the contact point 26. In an alternative embodiment (not shown), the biocidal portion 24 of the first portion 18 extends past the contact point 26, so that the microbes 40 are exposed to a greater biocidal portion 24 and a larger amount of biocidal materials. In such an alternative embodiment, the entire perimeter of the space 52 includes biocidal material, including the biocidal portion 24 of the first portion 18 and the edge 12B of the biocidal material layer 10 and the biocidal portion of the second portion 19, greatly inhibiting the welfare of microbes 40.

By providing the biocidal portion 24 of the patterned adhesive layer 20 with a different color than that of the biocidal material layer 10 as discussed above, the exposed edge 12 color will contrast with the biocidal material layer 10 when the biocidal article 5 is properly wrapped in a helix or spiral around the support 12. By observing the edge 12 color corresponding to the biocidal portion 24, one who wraps the biocidal article 5 around the support 12 can properly align the successive overlap portions 50. Note that, if only one edge 12 corresponds to the colored biocidal portion 24 (as in FIGS. 1 and 2), the helical wrap must have the proper direction (either clockwise or counterclockwise) corresponding to the orientation of the biocidal article 5 to expose the differently colored edge 12 of the biocidal portion 24 (as shown in FIG. 13). If, on the other hand, one of the embodiments of FIGS. 3-5 is used, the helical wrap can be in either the left hand or right hand orientation (clockwise or counterclockwise) since either edge 12 is exposed (as shown in FIG. 14).

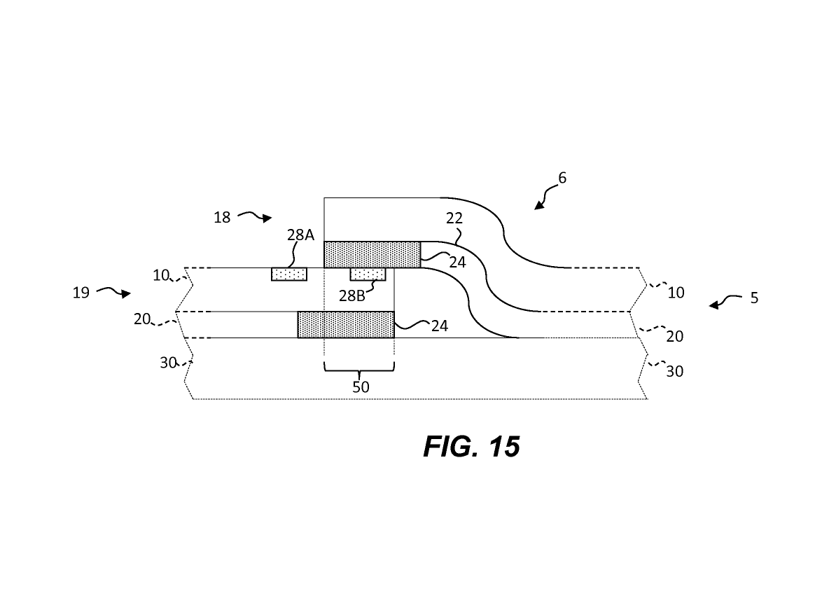

In a further embodiment of the present invention, the visible marks 28A or 28B on the biocidal material layer 10 (see FIGS. 9-12) of the helically wound biocidal article 5 are covered, or at least a portion of the visible marks 28A or 28B are covered. The visible marks 28A, 28B can indicate a minimum desired overlap 50 of the first and second portion 18, 19. In an embodiment illustrated in FIG. 15, multiple visible marks 28A, 28B are used to indicate both a minimum and a maximum desired overlap 50 of the first and second portions 18, 19 of the biocidal article 5 having a biocidal material layer 20 and patterned adhesive layer 20. The minimum mark 28A is covered by the overlap 50 and the maximum mark 28B is not covered by the overlap 50. Such visible marks can ensure, for example, that the biocidal portions 24 extend appropriately into the space 52 at the overlap 50 so that the overlap 50 is adequate to inhibit the growth and reproduction of any microbes on the surface of the support 30, for example to ensure that the biocidal portion 24 of the first portion 18 extends past the contact point 26 (FIG. 14) but also maintains a reasonable overlap 50.

In other embodiments of the present invention, various portions of the biocidal device 6 have different colors to indicate various elements, actions, or states of the biocidal device 6. In one embodiment, at least a portion of the support 30 has a support color and the biocidal material layer 10 has a material color different from the support color or the patterned adhesive layer 20 has an adhesive color different from the support color. Such embodiments are useful to indicate the portion of the support 30 that is covered with the biocidal article 5.

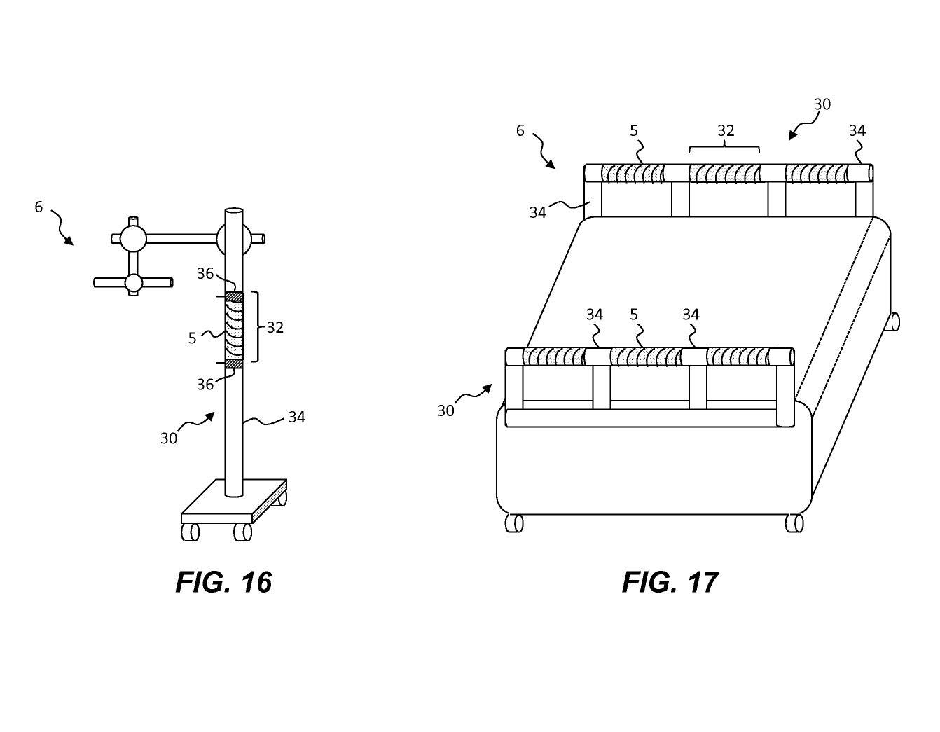

Referring to FIGS. 16 and 17, such a colored embodiment is also useful when the support 30 has a handle portion 32 intended for grasping or holding and a remaining portion 34 that is not intended for grasping or holding, for example by human hands and the biocidal material layer 10 is adhered to the handle portion 32. If the biocidal article 5, or some portion of the biocidal article 5 is colored differently from the support 30, the biocidal article 5 then serves to indicate to a user the handle portion 32 of the support 30 that is intended for handling and the remaining portion 34 is not intended for handling. If that portion, as is the case according to an embodiment of the present invention, has a biocidal material layer 10 adhered, then any microbes that would otherwise be transmitted to the surface of the support 30 will instead be transmitted to the biocidal material layer 10. Because the biocidal material layer 10 inhibits the welfare of microbes, the biocidal device 6 of the present invention will reduce the transmission of undesirable microbes from one person to another and from one place to another since microbes deposited on the biocidal material layer 10 by a contaminated person can die or weaken before an uncontaminated person handles the support 30. In a further embodiment of the present invention, a clamp 36 serves to affix the ends of the biocidal article 5 to the support 30. The clamp 36 is particularly useful for use with a biocidal tape. Such a clamp 36 can be mechanical or employ stretchable materials, for example a rubber band, or shrink wrap materials. Alternatively, the ends of the biocidal material layer 10 are adhered to the support 30. The clamp 36 can be removable from the biocidal device 6. The biocidal article 5 can also be removed from the support 30, for example with a suitable selection of adhesive for the patterned adhesive layer 20 so that the biocidal material layer 10 is removably adhered to the support 30 with the patterned adhesive layer 20.

In further embodiments of the present invention, the handle portion 32 has a handle color and the remaining portion 34 has a color different from the handle portion 32, thereby further distinguishing the portion of the support 30 that is intended for handling. In an embodiment, the handle portion 32 is a vertical portion of the support 30, as illustrated in FIG. 16. Referring to FIG. 17, the handle portion 32 is a horizontal portion of the support 30. The support 30 can have a length and a cross section diameter D, and the length L is greater than the cross section diameter D (FIG. 13). The support 30 can have a rectangular cross section, a circular cross section, an elliptical cross section, or has a cross section that is a cross section of a cylinder. The support 30 can be cylindrical, conical, or have a cross section of a cylinder, or have a cross section of a cone. The support 30 can be elastic or flexible and can take a variety of forms. For example, in various embodiments the support 30 is medical equipment, is part of a medical device, is used for medical purposes, is used in a medical facility, is a transportation device moved by hand, the biocidal article 5 is adhered to a horizontal portion of the support 30, or the support 30 is a device for hanging goods that is moved by hand, or the biocidal article 5 is adhered to a vertical portion of the support 30.

The textile biocidal material layer 10 was coated with an adhesive layer and applied it in a spiral-wound configuration to a cylindrical support 30, both with and without a clamp 36. The cylindrical support 30 included a handle portion 32 for grasping with a hand and a remaining portion 34 not intended for grasping with a hand.

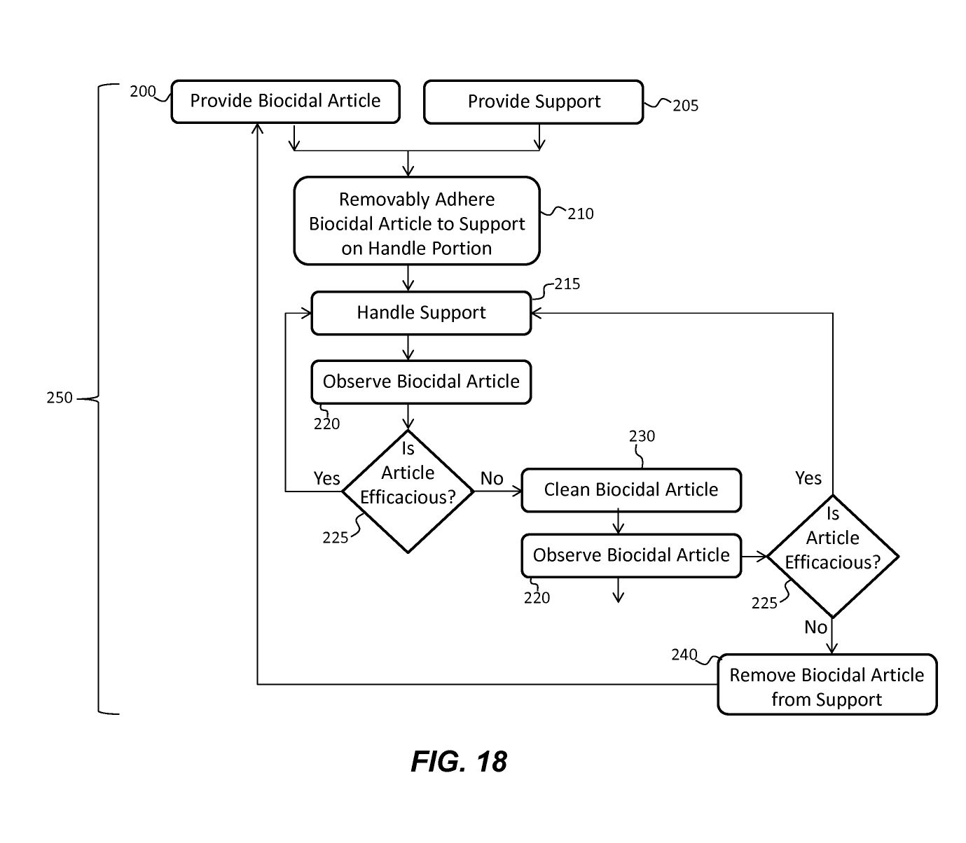

According to an embodiment of the present invention illustrated in FIG. 18, a method of using the biocidal article 5 includes first providing the biocidal article 5 in step 200 and a support 30 is provided in step 205. The biocidal article 5 is adhered with the patterned adhesive layer 20 to the handle portion 32 of the support 30 in step 210. In one embodiment, the adhesion is permanent, in another embodiment, the adhesion is releasable. In step 215, the handle portion 32 is handled, for example during normal use of the biocidal device 6. If the support 30 is, for example, a portable device for hanging bags of liquid medication, such as an I.V. stand, the handle portion can a vertical support metal bars, as shown in FIG. 16 and handling is accomplished by moving the I.V. stand from one place to another. If the support 30 is, for example, a transportation device for a recumbent patent such as a bed or gurney on wheels, the handle portion can be horizontal metal bars at the head or foot of the bed or gurney, as shown in FIG. 17 and handling is accomplished by pushing the bed or gurney from one place to another.

The biocidal article 5 is observed in step 220 over time. If it appears to be clean and relatively new, the biocidal article 5 is determined to be efficacious in step 225 and the biocidal device 6 continues in use in step 215. If the biocidal article 5 becomes dirty or the support 30 or patterned adhesive layer 20 shows through the biocidal material layer 10, especially if they are differently colored, the biocidal article 5 is determined to be inefficacious in step 225. Alternatively, the biocidal article 5 includes light-responsive materials that emit light in response to electromagnetic radiation. In a further method of the present invention, the biocidal article 5 is illuminated and a response to the illumination observed. The illumination can be ultra-violet radiation and the light response of the biocidal article 5 is visible light.

Optionally, the biocidal article 5 is cleaned in step 230 and observed again in step 220. If the optional cleaning is successful, the biocidal device 6 continues in use in step 215. If not the biocidal article 5 is removed from the support 30 and the biocidal device taken out of service in step 240 and a new biocidal article 5 is provided in step 200 removably adhered to the support 30 in step 210. Alternatively, in another embodiment the biocidal article 5 is replaced or cleaned on a regular schedule determined by prior testing so that the use and replace cycle step 250 is reduced to a periodic optional cleaning and eventually replacement of the biocidal article 5 on the support 30.

The optional cleaning step 230 can change the color of the biocidal article 5, as can abrading the biocidal material layer 10, or handling the biocidal device 6. A chemical modification to the biocidal article 5 can change the color of the biocidal article 5 or improve the efficacy of the biocidal article 5.

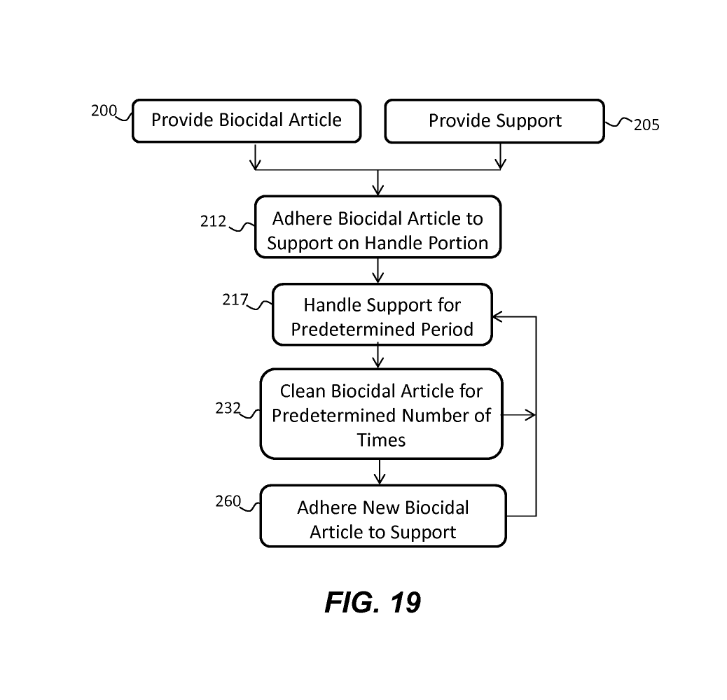

Referring to FIG. 19, the biocidal article 5 is cleaned and a new biocidal article adhered to the support 30 on a regular schedule without removing the prior biocidal article 5. In such an embodiment, a method of using the biocidal article 5 includes first providing the biocidal article 5 in step 200 and the support 30 is provided in step 205. The biocidal article 5 is adhered with the patterned adhesive layer 20 to the handle portion 32 of the support 30 in step 212. In step 217, the handle portion 32 is handled for a predetermined period, for example during normal use of the biocidal device 6. The biocidal article 5 is optionally cleaned in step 232 a predetermined number of times after each predetermined period of normal use (step 217). After the biocidal article 5 is optionally cleaned in step 232 the maximum number of times desired, a new biocidal article 5 is adhered to the support 30 in step 260, for example over the top of the old biocidal article 5 so that the first biocidal article 5 is adhered over a second biocidal article.

In yet another embodiment, the biocidal device 6 is a one-time use device and after the biocidal device 6 is used it is discarded, regardless of the efficacy of the biocidal article 5.

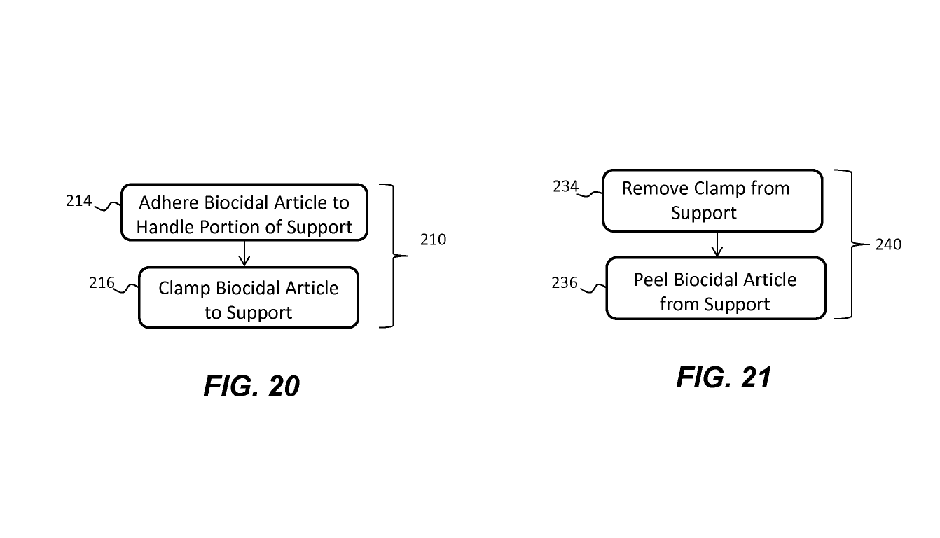

In an embodiment of the present invention, a clamp is used to assist in holding the biocidal article 5 to the support 30. Referring to FIG. 20, the biocidal article 5 is removably or permanently adhered to the handle portion 32 of the support 30 in step 214. In step 216, the biocidal article 5 is clamped to the support 30 with a clamp 36, implementing step 210. Alternatively, referring to FIG. 21, the clamp 36 is removed in step 234 and the biocidal article 5 is mechanically peeled away from the support 30 in step 236, implementing step 240.

In a useful embodiment of the present invention, the step of adhering the patterned adhesive layer 20 to the support 30 includes wrapping the biocidal article 5 around the support 30, for example in a helix or spiral around the support 30 so that the first portion 18 of the biocidal article 5 overlaps the second portion 19 of the biocidal article 5 and the first portion 18 is different from the second portion 19. Furthermore, in an embodiment the support 30 has the handle portion 32 and the remaining portion 34 and the method further includes wrapping the biocidal article 5 to the handle portion 32 and not to the remaining portion 34. The biocidal article 5 can have a length L greater than a width W and form a tape with ends and the method can further include clamping the ends of the tape to the support 30.

According to various embodiments of the present invention, the optional cleaning process of step 230 gradually abrades or dissolves the biocidal material layer 10 so that over time the biocidal material layer 10 is at least partially removed. If the biocidal material layer 10 and the patterned adhesive layer 20 are differentially colored, over time the color of the patterned adhesive layer is revealed. As long as the biocidal material layer 10 remains sufficiently in place, no color or pattern change is observed in step 220 and the periodic cleaning continues. Eventually, the color change is observed in step 225 and the biocidal article 5 is replaced. Alternatively, when the biocidal article 5 appears dirty, it can be cleaned, replaced, or covered with a new biocidal article 5.

Chemical or heat treatments are applied to the biocidal article 5 can loosen, dissolve, reduce the adhesion of, or remove the patterned adhesive layer 20 so the biocidal article 5 can be removed from the support 30. Alternatively, the biocidal article 5 is abraded and removed by abrasion from the support 30.

In an embodiment, the biocidal article 5 is repeatedly cleaned, for example by spraying the biocidal material layer 10 with a cleaning agent and then rubbing or wiping the biocidal material layer 10. According to yet another embodiment of the present invention, the optional cleaning step 230 refreshes the biocidal material layer 10 so that the exposed biocidal particles 60 in the biocidal material layer 10 are more efficacious. This can be done, for example, by ionizing the biocidal particles 60, by removing oxidation layers on the biocidal particles 60, or by removing extraneous materials such as dust from the biocidal particles 60.

Useful cleaners include hydrogen peroxide, for example 2% hydrogen peroxide, water, soap in water, or a citrus-based cleaner. In an embodiment, the 2% hydrogen peroxide solution is reactive to make oxygen radicals that improve the efficacy of biocidal particles 60. In various embodiments, cleaning is accomplished by spraying the biocidal article 5 with a cleaner and then wiping or rubbing the biocidal material layer 10. The cleaner can dissolve the biocidal material layer 10 and the wiping or rubbing can remove dissolved material or abrade the biocidal material layer 10 to expose other biocidal particles 60 or increase the exposed surface area of exposed particles 62.

In embodiments of the present invention, a method of making the biocidal device 6 includes providing a support 30, providing a biocidal material layer 10 having edges 12, the exposed side 14, and the adhesive side 16 opposing the exposed side 14. The adhesive layer 20 is formed. The adhesive layer 20 is patterned so that the adhesive layer 20 includes a non-biocidal portion 22 and a biocidal portion 24 that extends to an edge 12 of the adhesive layer 20. The biocidal portion 24 includes biocidal materials. The biocidal material layer 10 is adhered to at least a portion of the support 30 with the adhesive layer 20 so that the biocidal portion 24 extends to at least one edge 12 with at least a part of the biocidal portion 24 exposed to form a biocidal device 6. In various embodiments of the present invention, the biocidal material layer 10 is adhered to the support 30 before or after the adhesive layer 20 is patterned and the adhesive layer is formed on either the biocidal material layer 10 or the support 30.

In one embodiment, the adhesive is provided as an unpatterned layer and then a portion of the unpatterned adhesive layer is treated, for example with the biocidal material to pattern the adhesive layer and form the patterned adhesive layer 20. In another embodiment, a non-biocidal adhesive material is provided in a layer on the non-biocidal portion 22 and a biocidal adhesive material is provided in a layer on the biocidal portion 24.

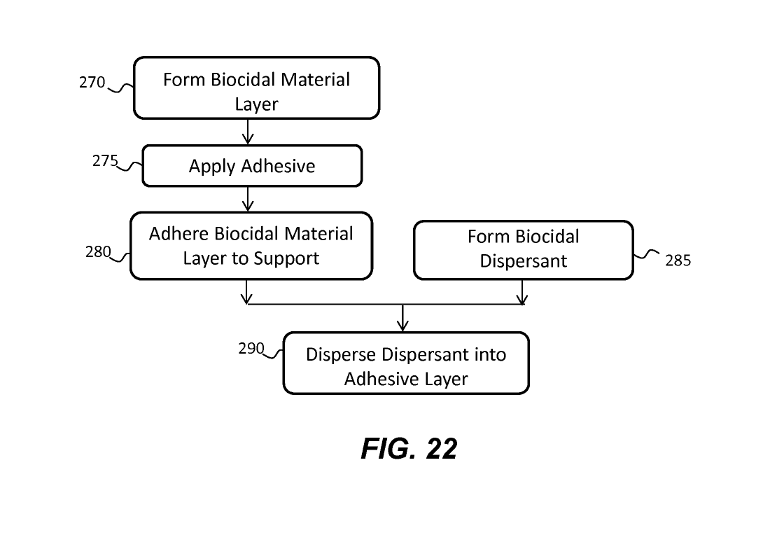

Referring to FIG. 22 in an embodiment of the present invention, the biocidal article 5 is formed by first forming a bi-layer structure including the biocidal material layer 10 having edges 12, the exposed side 14, and the adhesive side 16 opposing the exposed side 14 and an adhesive layer extending to the edges 12 of the biocidal material layer 10 including a non-biocidal portion 22. In an embodiment, the biocidal material layer 10 is formed in step 270 and an unpatterned adhesive applied in step 275. At least a portion of the bi-layer structure is adhered to a provided support 30 with the adhesive layer and at least a part of the non-biocidal portion 22 is exposed in step 280. A biocidal material dispersion is formed in step 285 and dispersed into the adhesive layer to form the patterned adhesive layer 20 that includes the non-biocidal portion 22 and the biocidal portion 24 in step 290. The biocidal portion 24 includes biocidal materials and extends to at least one edge 12. In a further embodiment, the biocidal material is dispersed into the adhesive layer by spraying a diffusible mixture containing a biocide onto at least a portion of the adhered biocidal article 5 to form the patterned adhesive layer 20.

In alternative embodiments of the present invention, the biocidal material is dispersed into the adhesive layer after the biocidal material layer 10 is adhered to the support 30 to form the patterned adhesive layer 20. If the biocidal material layer 10 is wrapped helically around the support 30, the exposed edge 12 is readily accessible to the dispersion. In such an embodiment, the dispersion is applied to the exposed edge 12 of the biocidal material layer 10 and adhesive layer. The dispersion soaks into the edge 12 of the adhesive layer to pattern the adhesive layer and form the patterned adhesive layer 20. In various embodiments, the dispersion is sprayed onto the entire biocidal material layer 10, the dispersion is applied only to the edges 12 of the biocidal material layer 10, or the support 30 and the biocidal material layer 10 are submerged into the dispersion.

In an alternative embodiment, the adhesive layer is applied to the support 30 and patterned on the support 30 to form the patterned adhesive layer 20.

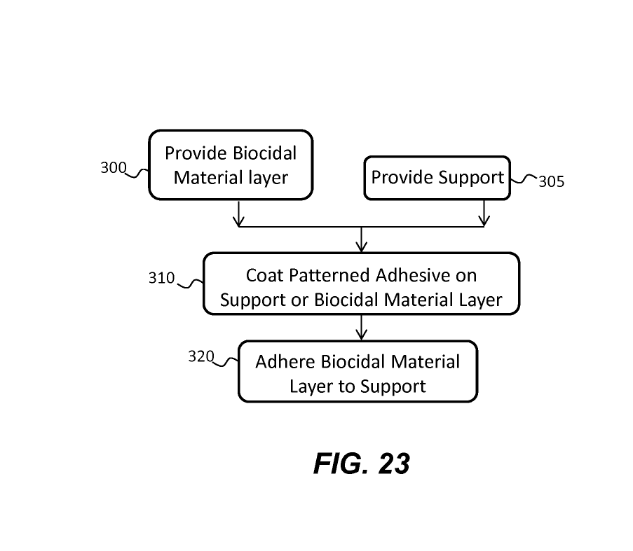

Referring to FIG. 23, the biocidal material layer 10 is provided in step 300 and a support provided in step 305. In step 310, a patterned adhesive is coated on the support 30 or the adhesive side 16 of the biocidal material layer 10. The biocidal material layer 10 is then adhered to the support in step 320.

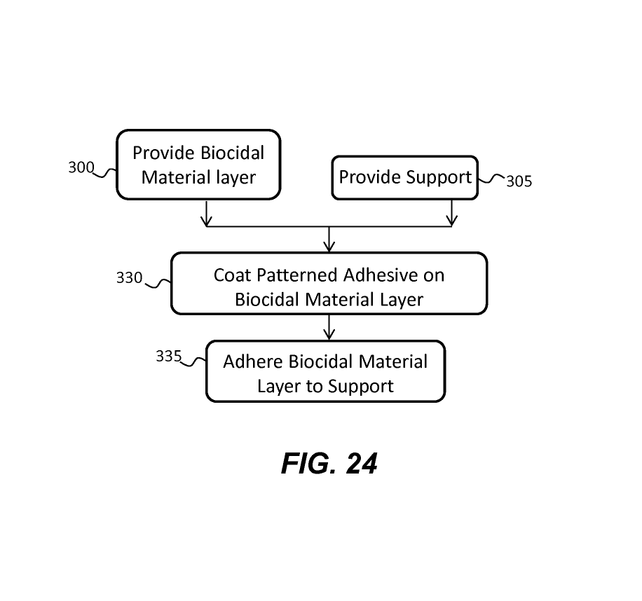

In a useful embodiment, the biocidal material layer 10 is provided as a freestanding layer (e.g. as a cloth, ribbon, textile) that is coated with the patterned adhesive layer 20 and then adhered to the support 30. Referring to FIG. 24, the biocidal material layer 10 is provided in step 300 and a support provided in step 305. In step 330, a patterned adhesive is coated on the adhesive side 16 of the biocidal material layer 10. The biocidal material layer 10 is then adhered to the support in step 335. In a useful embodiment, the biocidal material layer 10 is helically wrapped around the support 30. By coating the biocidal material layer 10 rather than the support 30 with adhesive, helical wrapping is facilitated.

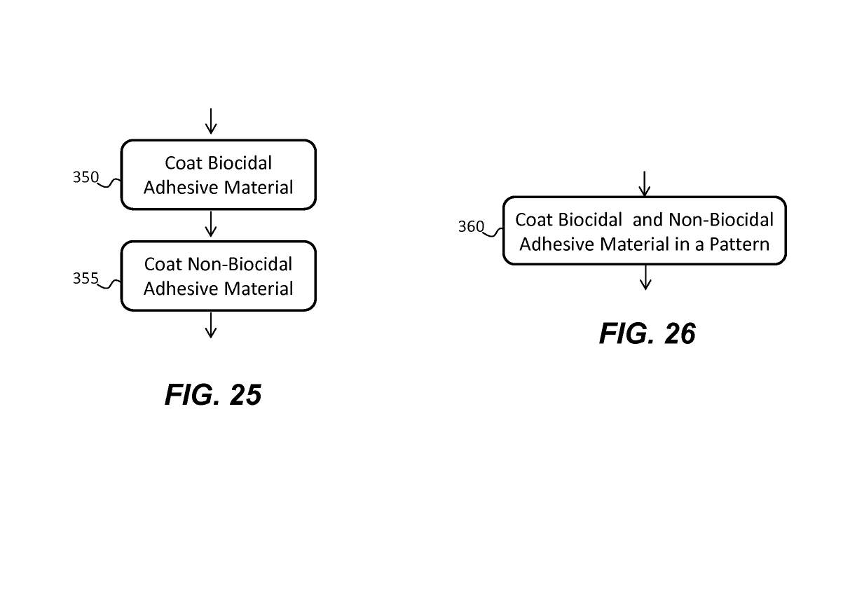

In an embodiment and as illustrated in FIG. 25, the biocidal and non-biocidal adhesive materials are coated separately at different times to form the patterned adhesive layer 20. As shown in FIG. 25, the biocidal adhesive material is coated on the support 30 or on the biocidal portion 24 of the biocidal material layer 10 in step 350 and the non-biocidal adhesive material is coated on the support 30 or on the non-biocidal portion 24 of the adhesive side 16 of the biocidal material layer 10 in step 355. Alternatively, the order of steps 350 and 360 is reversed. Referring to FIG. 26, in another embodiment the biocidal and non-biocidal adhesive materials are patternwise coated at the same time in step 360 to form the patterned adhesive layer 20 on the support 30 or the adhesive side 16 of the biocidal material layer 10.

The present invention is useful in a wide variety of environments and on a wide variety of supports 30 and in a wide variety of devices, particularly devices that are frequently handled by humans. The present invention can reduce the microbial load in an environment and is especially useful in medical facilities.

The invention has been described in detail with particular reference to certain embodiments thereof, but it will be understood that variations and modifications can be effected within the spirit and scope of the invention.

### PARTS LIST

A cross section line
B cross section line
D distance
L length
W width
5 biocidal article
6 biocidal device
10 biocidal material layer
12 edge
12A first portion edge
12B second portion edge
14 side
16 adhesive side
18 first portion
19 second portion
20 patterned adhesive layer
22 non-biocidal portion
24 biocidal portion
26 contact point
28, 28A, 28B visible mark
30 support
32 handle portion
34 remaining portion
36 clamp
40, 40A, 40B microbes
50 overlap
52 space
60 particle
62A binder
62B adhesive binder

### PARTS LIST CONT'D

200 provide biocidal article step
205 provide support step
210 removably adhere biocidal article to support step
212 adhere biocidal article to support step
214 adhere biocidal article to handle portion of support step
215 handle support step
216 clamp biocidal article to support step
217 handle support for period step
220 observe biocidal article step
225 check article efficacy step
230 clean biocidal article step
232 clean biocidal article for predetermined number of times step
234 remove clamp from support step
236 peel biocidal article from support step
240 remove biocidal article step
250 use and replace cycle step
260 adhere new biocidal article to support step
270 form biocidal material layer step
275 apply adhesive step
280 adhere biocidal material layer to support step
285 form biocidal dispersant step
290 disperse dispersant into adhesive layer step
300 provide biocidal material layer step
305 provide support step
310 coat patterned adhesive on support or biocidal material layer step

### PARTS LIST CONT'D

320 adhere biocidal material layer to support step
330 coat patterned adhesive on biocidal material layer step
335 adhere biocidal material layer to support step
350 coat biocidal adhesive layer step
355 coat non-biocidal adhesive material step
360 coat biocidal and non-biocidal adhesive material in a pattern step

1. A biocidal article, comprising:
a biocidal material layer having edges, an exposed side, and an adhesive side opposing the exposed side; and
a patterned adhesive layer located in contact with the adhesive side and extending to the edges of the biocidal material layer wherein the patterned adhesive layer includes a non-biocidal portion and a biocidal portion, the biocidal portion including biocidal materials and extending to at least one edge, wherein the non-biocidal portion and the biocidal portion of the patterned adhesive layer have the same adhesion.

2. The biocidal article of claim 1, wherein the biocidal material layer and the patterned adhesive layer form a sheet.

3. The biocidal article of claim 1, wherein the biocidal material layer has four edges and forms a rectangular layer.

4. The biocidal article of claim 1, wherein the biocidal portion extends along only one edge, only two edges, only three edges, or four edges.

5. The biocidal article of claim 1, wherein the biocidal material layer has a length greater than a width.

6. The biocidal article of claim 5, wherein the biocidal material layer and the patterned adhesive layer form a tape.

7. The biocidal article of claim 1, wherein the patterned adhesive layer covers the adhesive side of the biocidal material layer.

8. The biocidal article of claim 1, wherein the patterned adhesive layer covers only a portion of the adhesive side of the biocidal material layer.

9. The biocidal article of claim 1, wherein the biocidal material includes biocidal particles.

10. The biocidal article of claim 9, wherein the biocidal particles include metal, metal salts, silver, silver salt, copper, copper salt, silver sulfate, or silver chloride.

11. The biocidal article of claim 9, wherein the biocidal particles are located within a binder.

12. The biocidal article of claim 9, wherein the biocidal material layer has a surface and the biocidal particles extend from the surface.

13. The biocidal article of claim 1, wherein the biocidal material includes biocidal drugs.

14. The biocidal article of claim 1, wherein the biocidal material layer and the patterned adhesive layer are elastic or flexible.

15. The biocidal article of claim 1, wherein the biocidal material layer is woven.

16. The biocidal article of claim 1, wherein the biocidal material layer is a textile, cloth, plastic, or fabric.

17. The biocidal article of claim 1, wherein the biocidal material layer has a structured surface.

18. The biocidal article of claim 1, wherein the biocidal material layer is hydrophobic or oleophobic.

19. The biocidal article of claim 1, wherein the biocidal material layer has a material color and the patterned adhesive layer has an adhesive color different from the material color.

20. The biocidal article of claim 1, wherein the material color is blue or green or white or wherein the adhesive color is red or orange.

21. The biocidal article of claim 1, wherein the biocidal material layer or the patterned adhesive layer is transparent.

22. The biocidal article of claim 1, wherein the biocidal portion has an edge color and the non-biocidal portion has a color that is different from the edge color.

23. The biocidal article of claim 22, wherein the biocidal material layer has a material color and wherein the edge color is the same as the material color.

24. The biocidal article of claim 1, further including a visible mark on the biocidal material layer adjacent to the at least one edge indicating the biocidal portion of the patterned adhesive layer.

25. The biocidal article of claim 1, further wherein at least a portion of the visible mark is the same distance from the at least one edge as the distance from the at least one edge to the non-biocidal portion.

26. The biocidal article of claim 1, further including a visible mark on the biocidal material layer adjacent to an edge opposite to the at least one edge indicating the non-biocidal portion of the patterned adhesive layer.

27. The biocidal article of claim 1, further wherein at least a portion of the visible mark is the same distance from the opposite edge as the distance from the at least one edge to the non-biocidal portion.

28. The biocidal article of claim 1, further including a visible mark indicating a minimum overlap and a visible mark indicating a maximum overlap.
